(19) United States
(12) Patent Application Publication
(10) Pub. No.: US 2005/0088549 A1
(43) Pub. Date: Apr. 28, 2005

(54) Noise removing device for image sensor

(75) Inventors: Toshinobu Hatano, Kyoto (JP); Yukiko Okinaga, Saitama (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/972,451

(22) Filed: Oct. 26, 2004

(30) Foreign Application Priority Data
Oct. 27, 2003 (JP) P2003-365501

(51) Int. Cl. H04N 5/217

(52) U.S. Cl. 348/241

(57) ABSTRACT

The noise removing device for an image sensor according to the present invention is for reducing the noise in the output of the image sensor. The device comprises: a noise generator for generating the noise in common-mode with respect to the output of the image sensor; and a differential amplifier which amplifies the difference between the output of the image sensor and the output of the noise generator. By canceling the common-mode signals, 1/f noise, low-frequency noise, high-frequency noise, shot noise, beat noise and the like, which are asynchronous with the horizontal synchronizing signals, can also be reduced.

### BACKGROUND OF THE INVENTION

1. Field of the Invention

The present invention relates to a noise removing device used in an image sensor which is mounted to a digital camera and the like.

2. Description of the Related Art

The main streams of sensors for digital cameras have been CCD sensors. However, the characteristics of MOS sensors have been improved, thereby drawing attentions with high expectancy. Described in the following is an example of a conventional noise removing device for an image sensor, which achieves high S/N output of a sensor.

In an image pickup device shown in FIG. 10, a CCD image sensor a1 is driven by a control signal outputted from an image sensor driving circuit a6 and outputs a sensor output X shown in FIG. 11. The sensor output X comprises a reset section X1, a feed-through section X2, a pixel signal section X3 and the like. The reset section X1 is obtained when signal charge is discharged by a reset pulse RP from the driving circuit a6. The feed-through section X2 is stabilized in between from the reset to charging of the next signal charge under the state with reset noise and, subsequently, becomes the reference of a pixel signal to be charged. The pixel signal section X3 is obtained by charging the signal charge. As for the sensor output, the direct current level of the entire wave changes moderately due to overlapping of low-frequency noise.

In a CDS (Correlated Double Sampling) circuit a2, the feed-through section X2 is held as a sample by a feed-through/clamp pulse DS1 from the driving circuit a6 and the pixel signal section X3 is held as a sample by a sample pulse DS2. The reset noise and the low-frequency noise are removed by subtracting the two. Subsequently, it is amplified by an amplifier a3, clamped by a black-reference clamp circuit a4, and converted to a digital signal by an analog-digital converter a5.

As described above, by the noise processing performed in the CDS circuit, the reset noise and the low-frequency noise contained in the output signal of the image sensor can be removed. The noise is synchronized with horizontal synchronizing signals.

However, there remains a problem that 1/f noise, low-frequency noise, high-frequency noise, shot noise, and beat noise, which are asynchronous with the horizontal synchronizing signals, can not be reduced sufficiently.

### BRIEF SUMMARY OF THE INVENTION

In order to overcome the foregoing problem, the present invention cancels the noise by utilizing a common-mode signal rejecting function of a differential amplifier disposed in the back row.

(1) The noise removing device for an image sensor according to the present invention comprises: a noise generator for generating noise in common-mode with respect to output of an image sensor; and
a differential amplifier for amplifying a difference between the output of the image sensor and output of the noise generator.

With the configuration, it is also possible to reduce the 1/f noise, low-frequency noise, high-frequency noise, shot noise, beat noise and the like, which are asynchronous with the horizontal synchronizing signals.

Another noise removing device for an image sensor according to the present invention comprises:
a noise generator for generating common-mode noise, which is in common to the outputs of N-numbers (N is natural number of 2 or more) of image sensors, as reference signals; and
a differential amplifier for amplifying a difference between the outputs of the N-numbers of image sensors and the reference signals of the noise generator.

Still another noise removing device for an image sensor according to the present invention comprises:
N-numbers of noise generator for generating respective common-mode noise as reference signals corresponding to each output of N-numbers (N is natural number of 2 or more) of image sensors; and
N-numbers of differential amplifiers for amplifying, respectively, differences between the outputs of the N-numbers of image sensors and the N-numbers of reference signals of the N-numbers of noise generator.

With the configurations described above in (2), (3), it is possible to reduce the 1/f noise, low-frequency noise, high-frequency noise, shot noise, beat noise and the like, which are asynchronous with the horizontal synchronizing signals according to the characteristics of the outputs of the N-numbers of the image sensors.

Additional objects and advantages of the present invention will be apparent from the following detailed description of preferred embodiments thereof, which are best understood with reference to the accompanying drawings.

### BRIEF DESCRIPTION OF THE DRAWINGS

FIG. 1 is a block diagram showing a basic configuration of a noise removing device for an image sensor according to a first embodiment of the present invention;

FIG. 2 is a circuit diagram of the noise removing device for an image sensor, when used for an MOS-type image sensor, according to a first embodiment of the present invention;

FIG. 3 is a wave-form diagram of the sensor output according to the first embodiment of the present invention;

FIG. 4 is a circuit diagram of the noise removing device for an image sensor, when used for a CCD-type image sensor, according to the first embodiment of the present invention;

FIG. 5 is a block diagram of a noise removing device according to a second embodiment of the present invention, comprising an image sensor with multiple outputs and a single noise generator;

FIG. 6 is a block diagram of a noise removing device according to a third embodiment of the present invention, comprising an image sensor with multiple outputs and N-numbers of noise generators;

FIG. 7 is a block diagram of a noise removing device for an image sensor according to a fourth embodiment of the present invention;

FIG. 8 is a block diagram of a noise removing device for an image sensor according to a fifth embodiment of the present invention;

FIG. 9 is a block diagram of a noise removing device for an image sensor according to a sixth embodiment of the present invention;

FIG. 10 is a block diagram of a conventional noise removing device for an image sensor; and

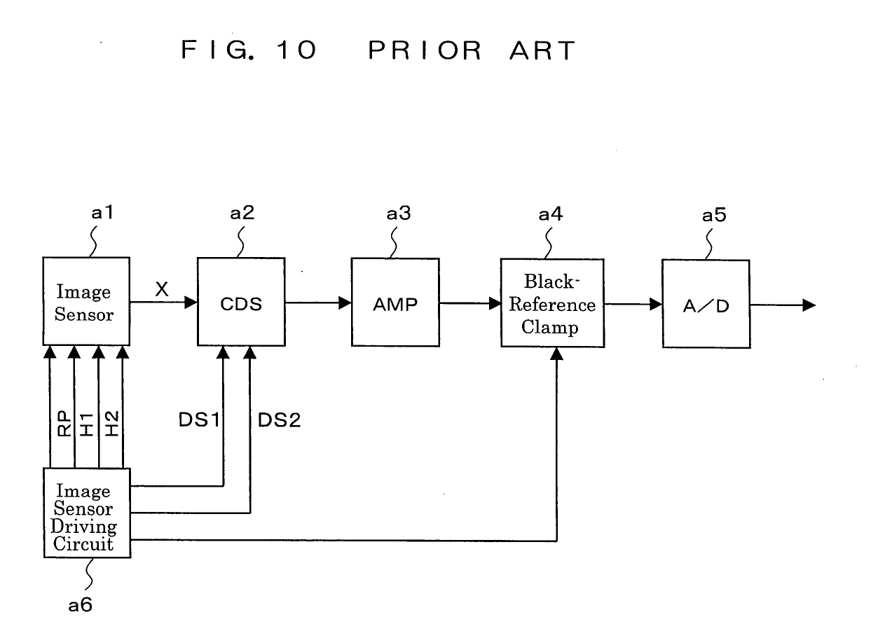

FIG. 11 is a wave-form diagram of the image sensor output.

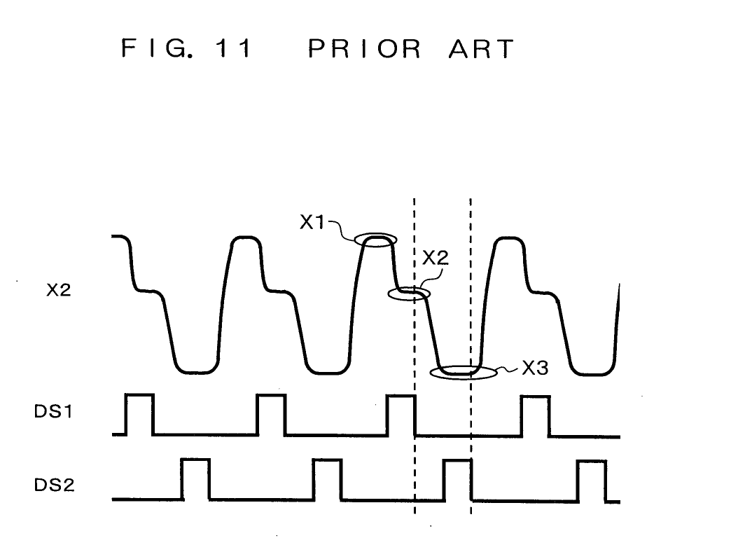

### DETAILED DESCRIPTION OF THE PREFERRED EMBODIMENTS

In the followings, embodiments of the noise removing device for an image sensor according to the present invention will be described in detail by referring to accompanying drawings.

### First Embodiment

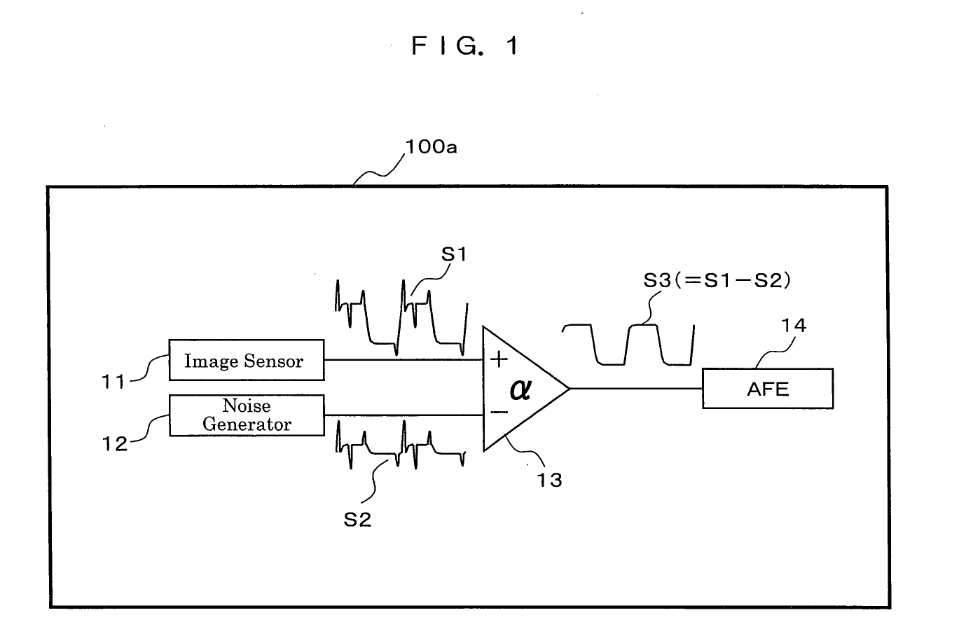

In FIG. 1 showing the configuration of a noise removing device 100a for an image sensor according to the first embodiment of the present invention for canceling the common-mode noise, numeral reference 11 is an image sensor of MOS type or CCD-type, 12 is a noise generator for generating a common-mode noise that is in same phase with the noise of the image sensor 11, 13 is a differential amplifier for carrying out amplification after subtracting the two inputted signals, one of that is an output signal S1 from the image sensor 11 and the other is a noise-reference signal S2 from the noise generator 12, and 14 is an analog front end (AFE) LSI. A noise-reference signal S2 contains 1/f noise, low-frequency noise, high-frequency noise, shot noise, beat noise and the like generated by the noise generator 12. Numeral reference S3 is a differential amplified output signal which is outputted from the differential amplifier 13.

By the common-mode rejecting function of the differential amplifier 13, the wave-form of the noise-reference signal S2 is subtracted from the wave-form of the image sensor output signal S1 which contains various kinds of noise. Thereby, the wave-form of the differential amplified output signal S3 becomes the wave-form without the noise. As described, it is possible to remove the noise using the image sensor, the noise generator and the differential amplifier.

By using the common-mode signal rejecting function of the differential amplifier 13, the noise-reference signal S2 is subtracted from the output signal S1 of a system of the image sensor 11 so as to cancel the noise and increase the gain. Thereby, it enables to achieve high S/N output of the sensor.

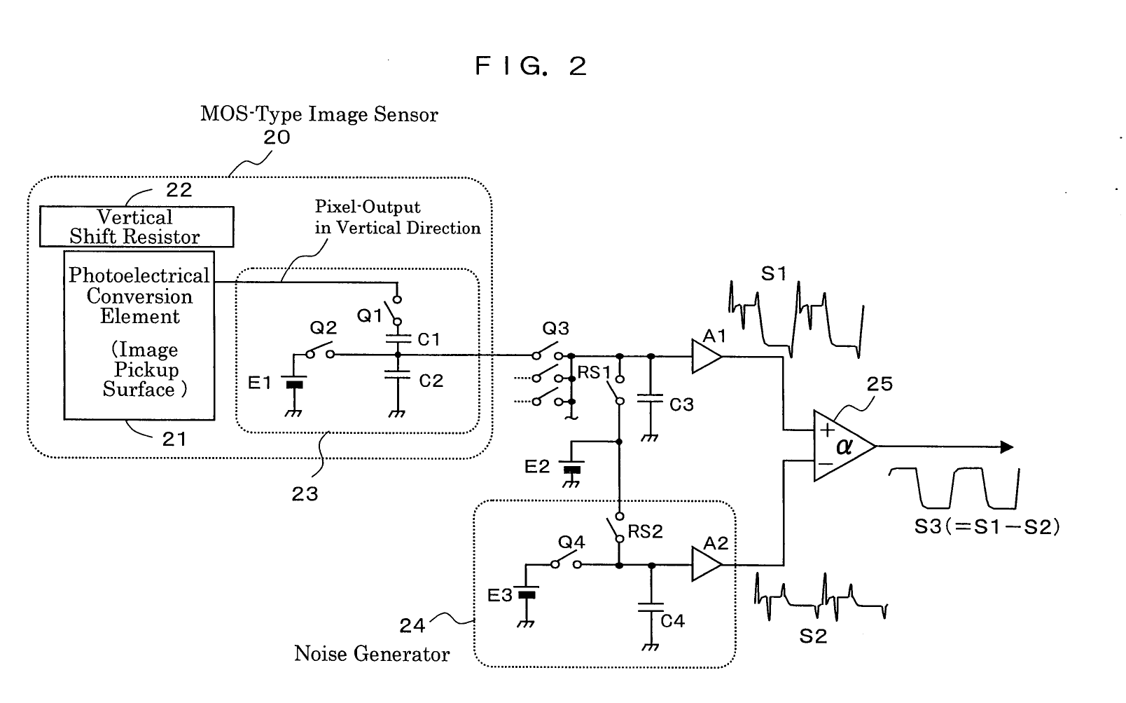

FIG. 2 shows a noise removing device for an image sensor, used in a MOS-type image sensor to which a noise generator is added.

In FIG. 2, numeral reference 20 is a MOS-type image sensor, 21 is a photoelectrical conversion element array, 22 is a vertical shift resistor, 23 is a noise-cancel/pixel-signal holding circuit within the MOS-type image sensor, 24 is a noise generator and 25 is a differential amplifier.

In the MOS-type image sensor 20, the signal charges which are photoelectrical-converted in photodiode of the photoelectrical conversion element array 21 are voltage-outputted by an amplifier of each cell (cell amplifier), when selected by the vertical shift resistor 22. Then, after being held by the noise-cancel/pixel-signal holding circuit 23, they are outputted as voltage signals when selected by a horizontal shift resistor (not shown). FIG. 2 shows only a single voltage signal output selected by the horizontal shift resistor.

The noise-cancel/pixel-signal holding circuit 23 comprises a vertical transfer switch Q1, a clamp condenser C1, a clamp switch Q2, a clamp reference power source E1, and a signal voltage holding condenser C2.

Reading-out of the pixel data of any single pixel in the element array 21 is carried out as follows. A signal output condenser C3 is reset to VDD level of the reset power source E2 through operating a reset switch in the front row of an output amplifier A1. The condenser C1 is reset by applying the direct current power source E1 for clamping through operating the switch Q2 of the noise-cancel/pixel-signal holding circuit 23. The pixels in the element array 21 are formed by combinations of the photodiode and the cell amplifier (floating diffusion amplifier). The electric charges accumulated in the photodiodes are outputted in a form of voltage through the cell amplifier. There is dispersion in the threshold values of the voltage VT of transistors of the cell amplifiers, which becomes the off-set component for deteriorating the picture quality (for example, vertical lines). This is referred to as noise and the noise is cancelled by the noise-cancel/pixel-signal holding circuit 23.

The pixel data of the pixel selected in horizontal/vertical directions of the element array 21 is read out by closing the vertical transfer switch Q1, and is held in the condenser C2. After transferring the pixel data to the condenser C2 by closing the horizontal transfer switch Q3, the output signal S1 is outputted through the output amplifier A1.

For pixel-data-reading-out lines in a number of longitudinal directions of the element array 21, the vertical transfer switch Q1, the condenser C1, the switch Q2, the condenser C2 are connected as a set. Each set is connected to the condenser C3 through the switch Q3. Thus, it is possible to add and mix the pixel data of a plurality of pixels in the condenser C3 through appropriately controlling the operation of the switch Q3.

When the output of a single pixel data is completed through the condenser C3, the condenser C3 is reset by operating the reset switch RS1.

The output signal S1 outputted from the output amplifier A1 contains the 1/f noise, low-frequency noise, high-frequency noise, shot noise, beat noise and the like. The noise generator 24 connected to the differential amplifier 25 for canceling the noise is formed with a direct current power source E3, a switch Q4, a condenser C4, an output amplifier A2, and a reset switch RS2. The direct current power source E3 corresponds to the direct current power source E1 for clamping. The switch Q4 corresponds to the switch Q2 and is operated by synchronizing with the switch Q2. The condenser C4 corresponds to the condenser 2. The output amplifier A2 corresponds to the output amplifier A1. The reset switch RS2 corresponds to the reset switch RS1 and is operated by synchronizing with the reset switch RS1. As described, the noise generating circuit 24 is in a circuit structure which is equivalent to that of the noise-cancel/pixel-signal holding circuit 23. The noise generating circuit 24 generates the same noise as the various noise components contained in the output signal S1 of the MOS-type image sensor 20.

The output terminal of the output amplifier A1 in the noise-cancel/pixel-signal holding circuit 23 is connected to a non-inverting input terminal (+) of the differential amplifier 25, and the output terminal of the output amplifier A2 of the noise generator 24 is connected to an inverting input terminal (−) of the differential amplifier 25.

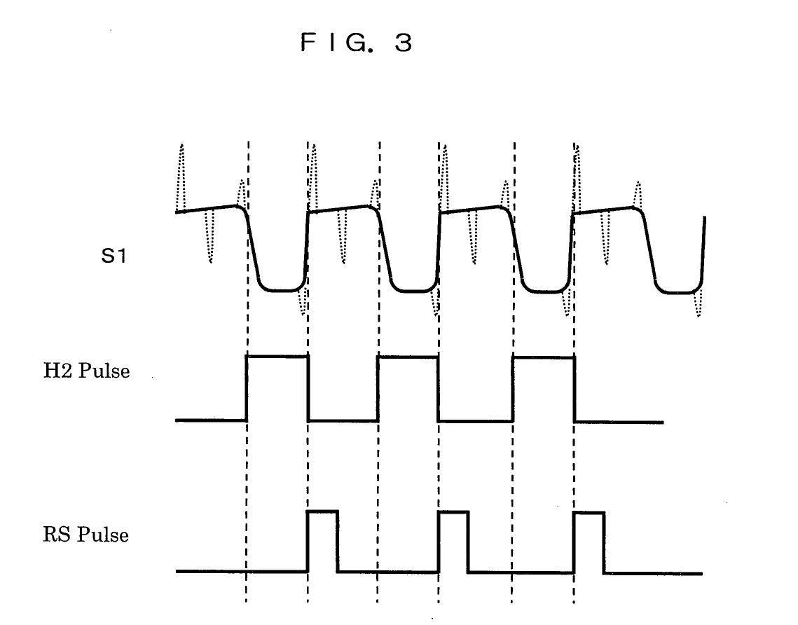

FIG. 3 shows the timing of a horizontal-line-output reading-out pulse (H2 pulse) applied to the switch Q4 which corresponds to the switch Q2 and the noise generator 24 shown in FIG. 2, the timing of the reset pulse (RS pulse) applied to the reset switch RS2 of the noise generating circuit 24, which correspond to the reset switch RS1, and the wave-form of the sensor output signal S1.

By repeating the operation of the switches Q3, Q4 and the operation of the reset switches RS1, RS2 at the timing as shown in FIG. 3, the sensor output signal S1 is outputted from the MOS-type image sensor 20. Synchronously, a noise-reference signal S2 is generated from the noise generating circuit 24. Thus, it is possible to obtain by the differential amplifier 25 a differential amplified output signal S3 which is a result of subtracting the noise-reference signal S2 of the noise generating circuit 24 from the sensor output signal S1. It enables to cancel the various noise components contained in the sensor output signal S1, such as the 1/f noise, low-frequency noise, high-frequency noise, shot noise and beat noise, by the noise-reference signal S2 in common-mode and same wave-form as those of the various noise. The differential amplified output signal S3 does not contain the noise components such as the 1/f noise, low-frequency noise, high-frequency noise, shot noise and beat noise.

In the aforementioned description, it has been described by referring to the case of using the MOS-type image sensor. However, the present invention may be applied to the CCD-type image sensor instead.

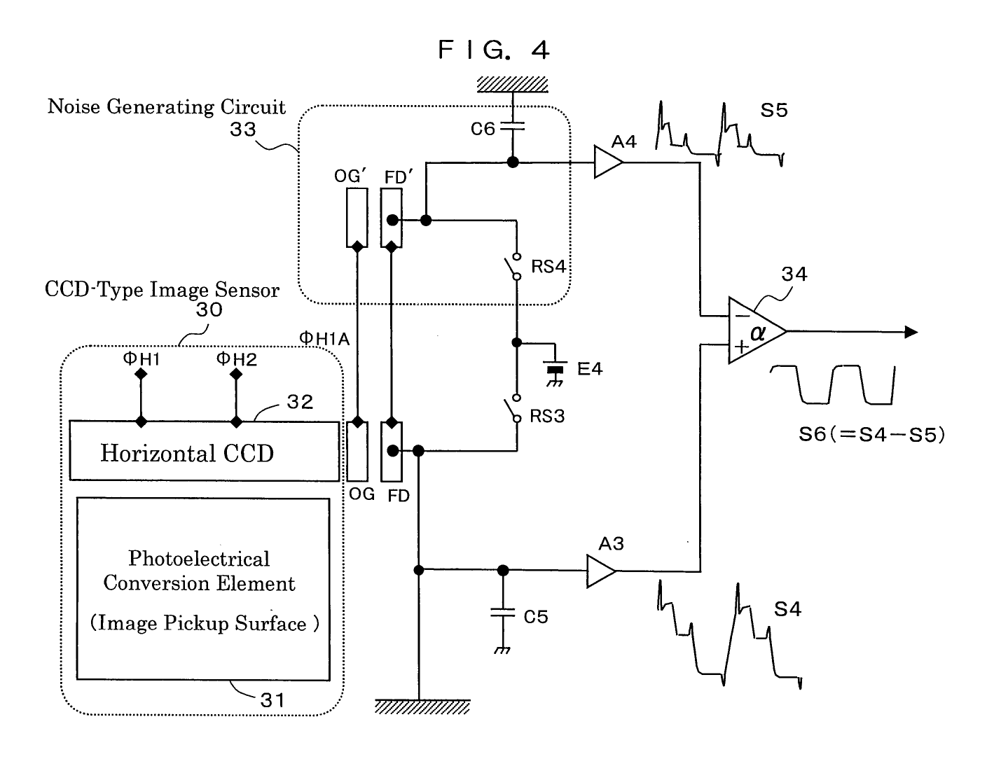

FIG. 4 shows a noise removing device for an image sensor, used in a CCD-type image sensor to which a noise generator is added. Numeral reference 30 is a CCD-type image sensor, 33 is a noise generating circuit, and 34 is a differential amplifier. In the CCD-type image sensor, the signal charges which are photoelectrical-converted by the photodiodes of the photoelectrical conversion element array are transferred by the vertical CCD and horizontal CCD and then accumulated in a floating diffusion section FD of a floating diffusion layer through an output gate OG. The accumulated electrical charges are converted to voltage in the output amplifier A3 to be outputted as voltage signals.

The noise generating circuit 33 comprises: the output gate OG; the floating diffusion section FD; an output gate OG′ and a floating diffusion section FD′, which are equivalent to a signal output condenser C5 and a reset switch RS3, respectively; a signal output condenser C6; and a reset switch RS4. An output amplifier A4 corresponds to the output amplifier A3. The noise generating circuit 33 generates the same noise as the various noise components contained in the image sensor output signal S4 of the CCD-type sensor 30.

The output terminal of the output amplifier A3 is connected to a non-inverting input terminal (+) of the differential amplifier 34, and the output terminal of the output amplifier A4 of the noise generating circuit 33 is connected to an inverting input terminal (−) of the differential amplifier 34.

The action in this case is basically the same as that of the above-described case. The sensor output signal S4 is outputted from the CCD-type image sensor 30 by repeating the synchronous operation of the reset switches RS3, RS4. Synchronously, a noise-reference signal S5 is generated from the noise generating circuit 33. Thus, it is possible to obtain by the differential amplifier 34 a differential amplified output signal S6 which is a result of subtracting the noise-reference signal S5 of the noise generating circuit 33 from the sensor output signal S4. It enables to cancel the various noise components contained in the sensor output signal S1, such as the 1/f noise, low-frequency noise, high-frequency noise, shot noise and beat noise, by the noise-reference signal S5 in common-mode and same wave-form as those of the various noise. The differential amplified output signal S6 does not contain the noise components such as the 1/f noise, low-frequency noise, high-frequency noise, shot noise and beat noise.

### Second Embodiment

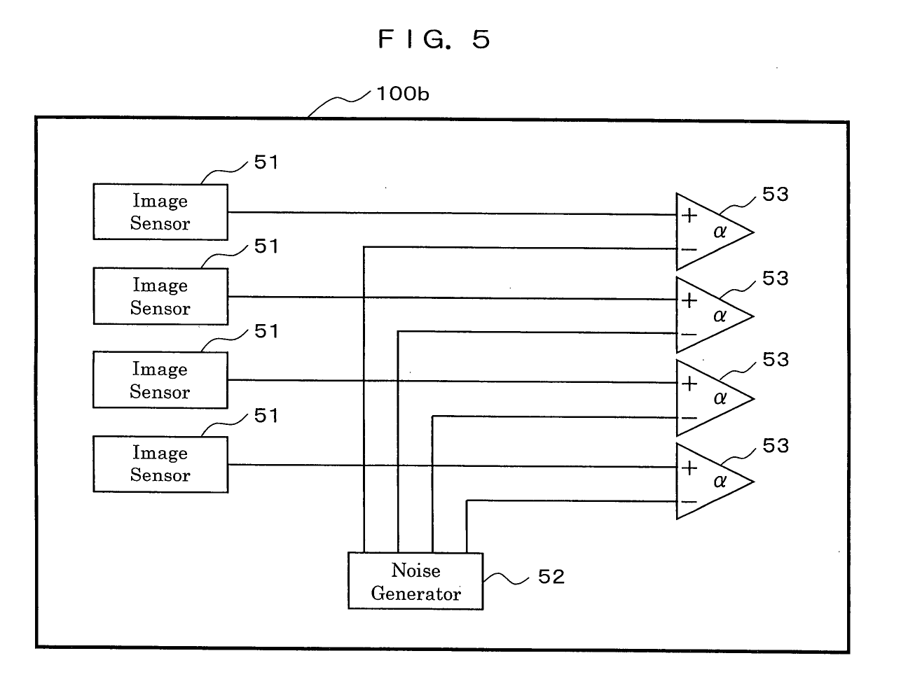

FIG. 5 is a block diagram showing the configuration of a noise removing device for an image sensor according to a second embodiment of the present invention. In the noise removing device 100b, for the multiple outputs by N-numbers (N is natural number of 2 or more)of image sensors 51, provided is a single noise generator 52 which generates the noise in common-mode with respect to the noise of the image sensors 51. Numeral reference 53 is a differential amplifier. Here, the noise on the multiple outputs from the image sensors 51 disposed on the same mask is assumed to be substantially the same.

### Third Embodiment

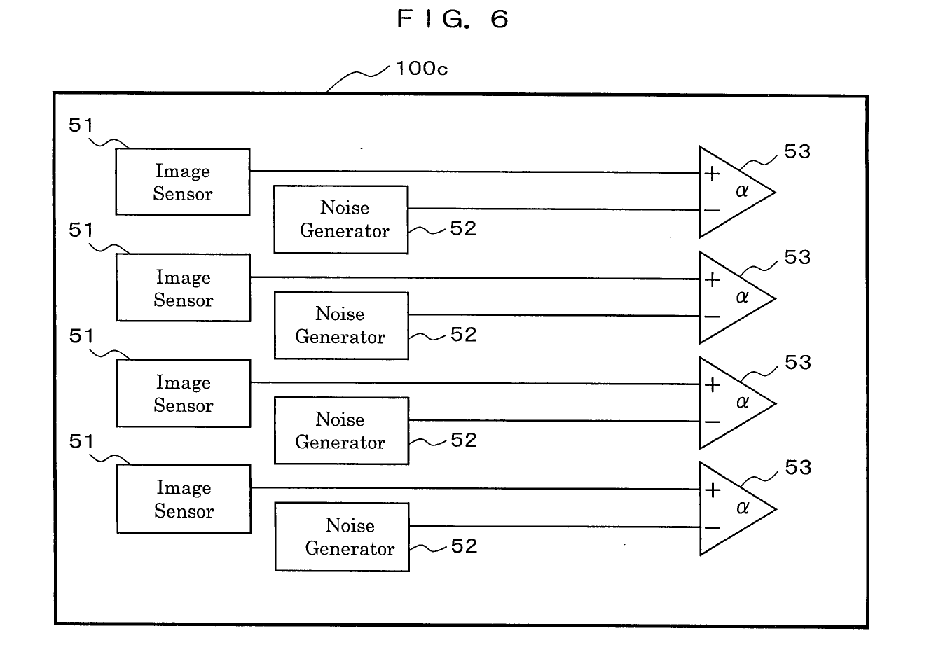

FIG. 6 is a block diagram showing the configuration of a noise removing device according to a third embodiment of the present invention. In a noise removing device 100c, for the multiple outputs by N-numbers of image sensors 51, provided are N-numbers of noise generators 52 which generate the noise in common-mode with respect to the noise of the image sensors 51.

### Fourth Embodiment

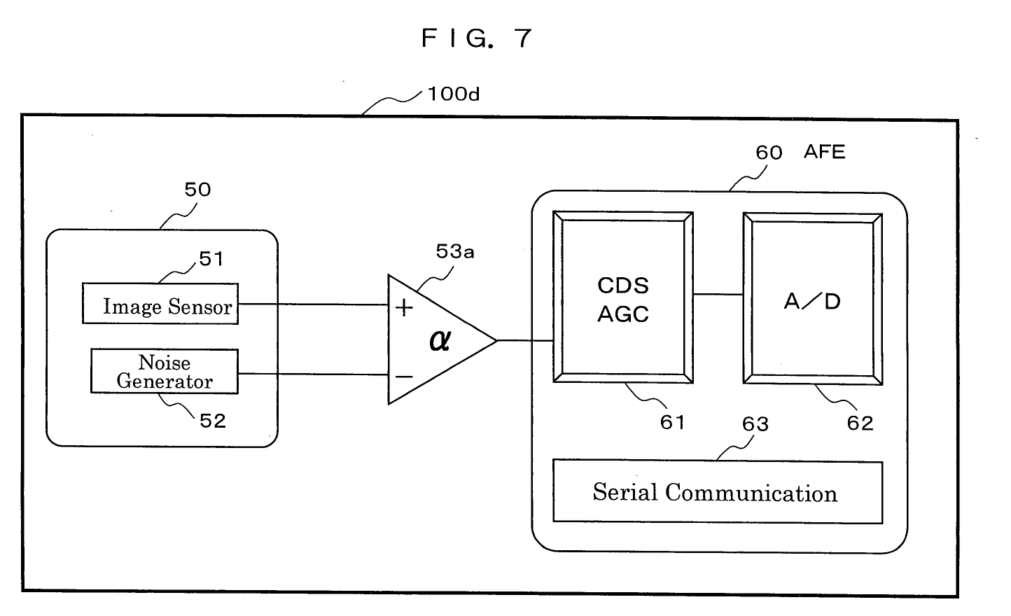

FIG. 7 shows a noise removing device 100d, comprising: an image sensor unit 50 formed with an image sensor 51 and a noise generator 52; an external differential amplifier 53a to which the outputs from the two systems of the noise generator 52 and the image sensors 51 are inputted; and an AFE 60. Numeral reference 61 is a CDS/AGC section, 62 is an A/D converter, and 63 is a serial communication unit.

### Fifth Embodiment

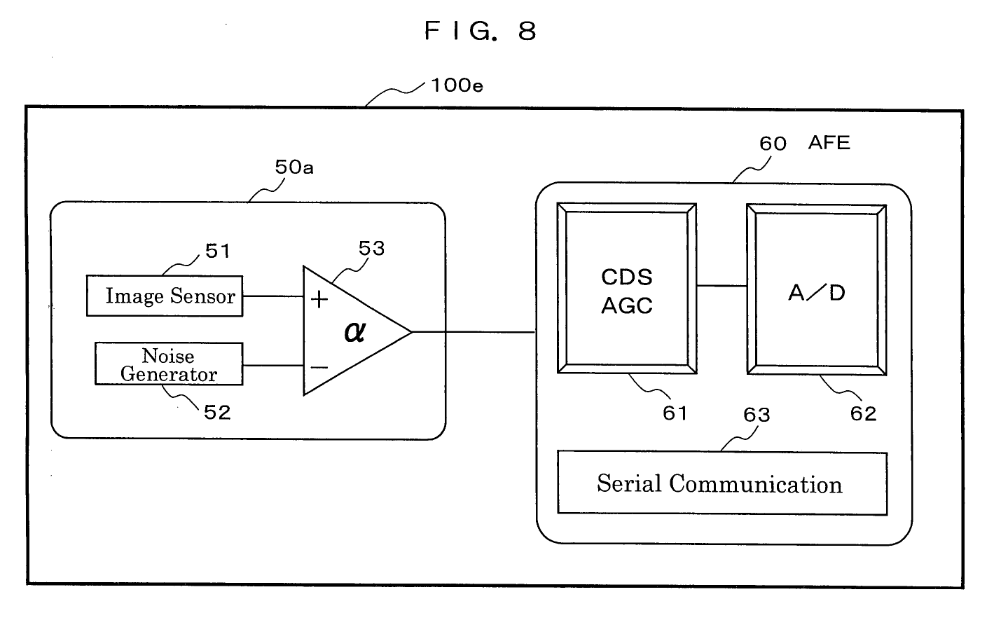

FIG. 8 shows a noise removing device 100e, comprising: am image sensor unit 50a having, in addition to the image sensor 51 and the noise generator 52, a differential amplifier 53; and an AFE 60. By employing the configuration in which the differential amplifier 53 is built-in to the image sensor unit 50a, a decrease in the number of components as well as a decrease in the power consumption can be expected.

### Sixth Embodiment

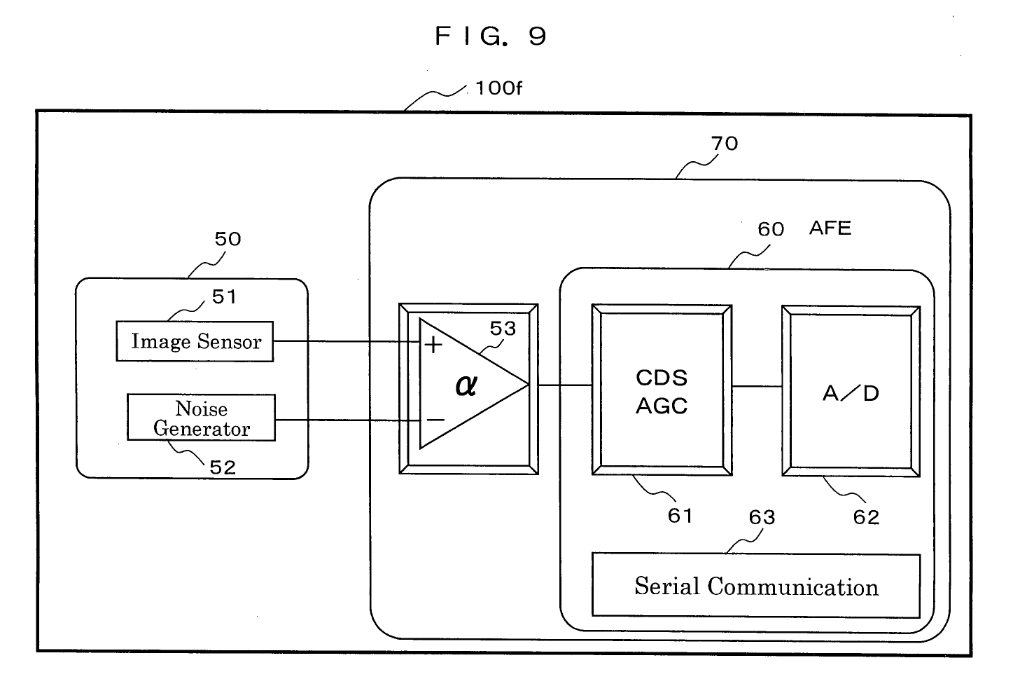

FIG. 9 shows a noise removing device 100f, comprising: an image sensor unit 50 formed with an image sensor 51 and a noise generator 52; and a noise removing section formed with a differential amplifier 53 and an AFE. Like the one shown in FIG. 8, by the configuration, a decrease in the number of components as well as a decrease in the power consumption can be expected.

As described above, with the noise removing device for an image sensor according to the present invention, it is possible to sufficiently reduce the noise such as the 1/f noise, low-frequency noise, high-frequency noise, shot noise, beat noise, which are asynchronous with the horizontal synchronizing signals.

Further, by providing a single noise generator in common to the N-numbers of the image sensors in the case where the output of the N-numbers of the image sensors generates common-mode noise, it becomes possible to provide a noise removing device at a reduced cost for a camera system to which a plurality of image sensors are mounted.

Moreover, in the case where the output of the N-numbers of the image sensors generate the common-mode noise with different characteristics from each other, by providing the N-numbers of noise generators corresponding to the N-numbers of the image sensors, it is possible to provide a noise removing device which can sufficiently reduce the noise in a camera system to which a plurality of image sensors are mounted.

The noise removing device for an image sensor according to the present invention is effective, in the images sensors mounted to the digital cameras and the like, as the device and the like for removing the 1/f noise, low-frequency noise, high-frequency noise, shot noise, beat noise and the like, which are asynchronous with the horizontal synchronizing signals.

The present invention is not limited only to the above-described embodiments but various modifications are possible within a spirit and scope of the appended claims.

1. A noise removing device for an image sensor, comprising:
a noise generator for generating noise in common-mode with respect to output of an image sensor; and
a differential amplifier for amplifying a difference between said output of said image sensor and output of said noise generator.

2. A noise removing device for an image sensor, comprising:
a noise generator for generating common-mode noise, which is in common to outputs of N-numbers (N is natural number of 2 or more) of image sensors, as reference signals; and
a differential amplifier for amplifying a difference between the outputs of said N-numbers of image sensors and said reference signals of said noise generator.

3. A noise removing device for an image sensor, comprising:
N-numbers of noise generator for generating respective common-mode noise as reference signals corresponding to each output of N-numbers (N is natural number of 2 or more) of image sensors; and
N-numbers of differential amplifiers for amplifying, respectively, differences between the outputs of said N-numbers of image sensors and said N-numbers of reference signals of said N-numbers of noise generator.
